(19) United States
(12) Patent Application Publication
(10) Pub. No.: US 2005/0168015 A1
(43) Pub. Date: Aug. 4, 2005

(54) Headliner with integrally-molded energy distribution zone

(75) Inventors: Geoffrey William Davey, Huntington Woods, MI (US); Normand R. Marceau, Linden, MI (US); Robert J. Winters, Brighton, MI (US); Erik Richard Davis, Oak Park, MI (US)

Correspondence Address: HONIGMAN MILLER SCHWARTZ AND COHN LLP, 32270 TELEGRAPH RD, SUITE 225, BINGHAM FARMS, MI, 48025-2457, US

(73) Assignee: Intier Automotive Inc.

(21) Appl. No.: 10/767,652

(22) Filed: Jan. 29, 2004

(51) Int. Cl. B60J 7/00

(52) U.S. Cl. 296/214

(57) ABSTRACT

A vehicular interior trim component, such as a headliner, includes a core having an exterior surface with at least one integrally-molded energy distribution zone. The at least one integrally-molded energy distribution zone may be embossed from the exterior surface of the core. Alternatively, the at least one integrally-molded energy distribution zone may be recessed in the exterior surface of the core. The integrally-molded energy distribution zone may have a generally sinusoidal cross-sectional shape to enable energy absorption from any direction.

### TECHNICAL FIELD

The present invention relates to vehicular interior trim components of a vehicle, and in particular to a headliner with at least one integrally-molded energy distribution zone for head impact situations.

### BACKGROUND OF THE INVENTION

Conventional headliner assemblies may include safety features. In one example, countermeasures, such as, for example, crush zones, may be tooled and then glued to a headliner substrate. The crush zones enhance the headliner by providing additional material, which is typically formed into a pyramid- or diamond-shape, to increase a thickness of the headliner. After the glue has cured and the crush zones are secured to the headliner substrate, a decorative fabric may be stretched over the adhered crush zones and headliner substrate.

Although adequate for most situations, conventional headliners with glued-on crush zones increases cost of the headliner as a result of having to tool and attach the crush zones to the headliner substrate. Additionally, crush zones in the shape of a pyramid or diamond tend to effectively manage energy when the force is applied in only one direction, such as, for example, in a generally perpendicular direction with respect to the crush zone of the headliner. However, in an accident situation, the headliner may be impacted from a variety of different directions. Thus, a need exists for an interior trim component, such as a headliner, with improved energy distribution zones, while also reducing and/or maintaining manufacturing costs.

### SUMMARY OF THE INVENTION

The inventors of the present invention have recognized these and other problems associated with vehicular trim components. To this end, the inventor has developed a vehicular interior trim component, such as a headliner. The headliner includes a core having an exterior surface with at least one integrally-molded energy distribution zone. A method of manufacturing the headliner is also disclosed.

### BRIEF DESCRIPTION OF THE DRAWINGS

The present invention will now be described, by way of example, with reference to the accompanying drawings, in which:

FIGS. 1A-1F illustrate top perspective views of headliners according to several alternate embodiments of the invention;

FIG. 2 is a perspective view of a portion of a headliner with at least one integrally-molded energy distribution zone according to another embodiment of the invention; and

FIG. 3 is a cross-sectional view of the headliner taken along line 3-3 of FIG. 2.

### DESCRIPTION OF THE PREFERRED EMBODIMENTS

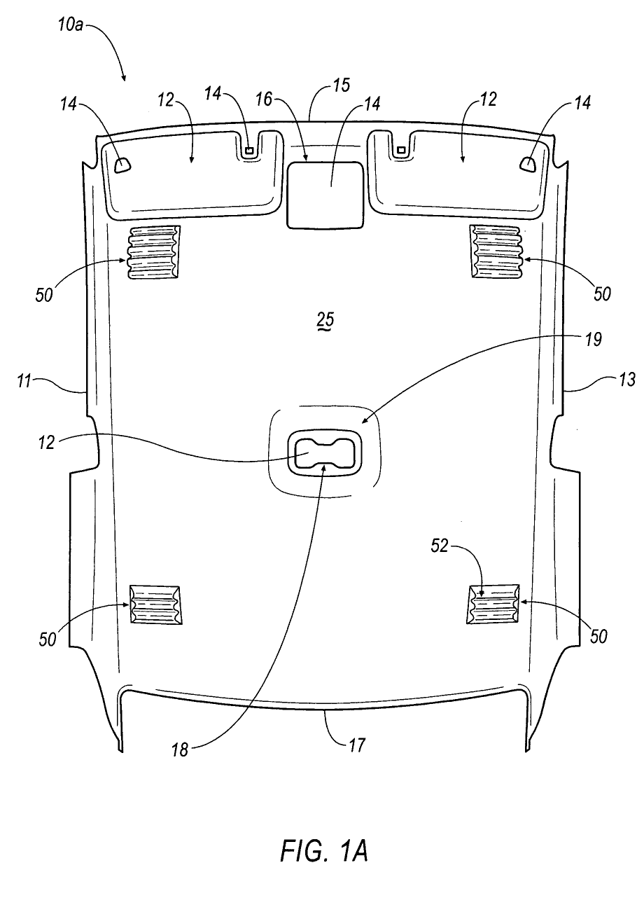

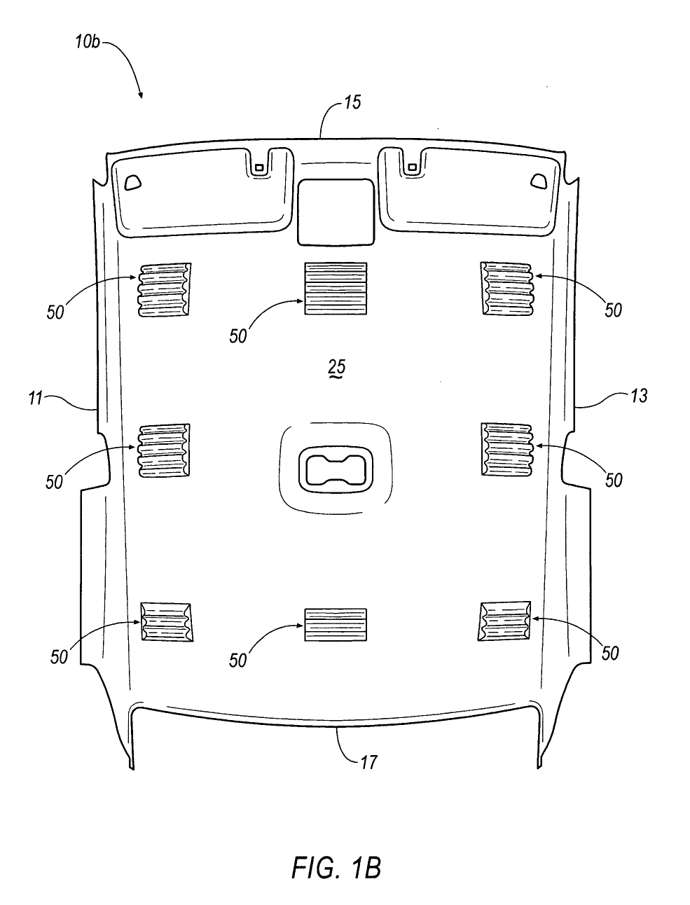

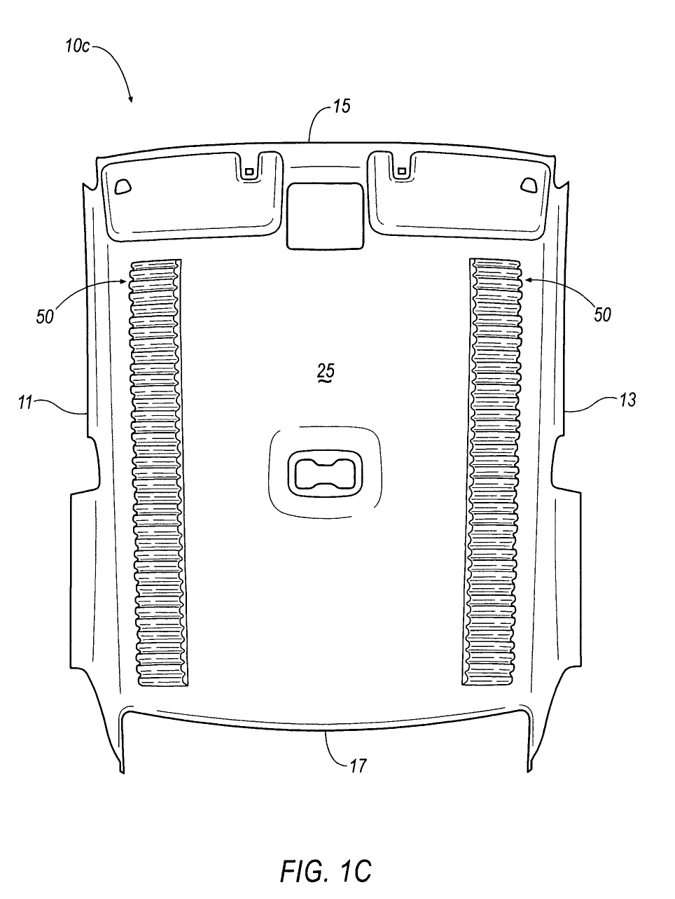

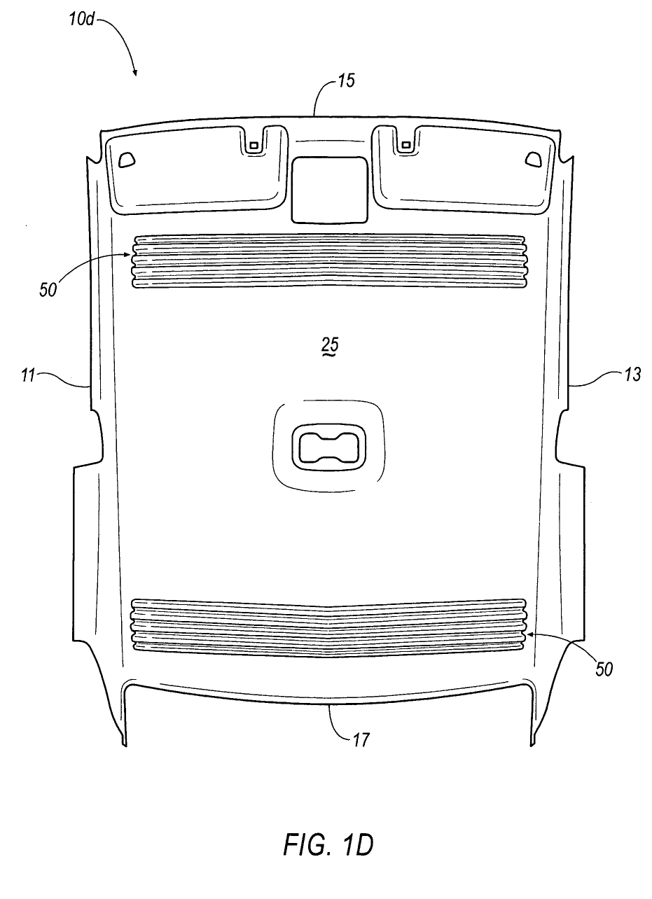

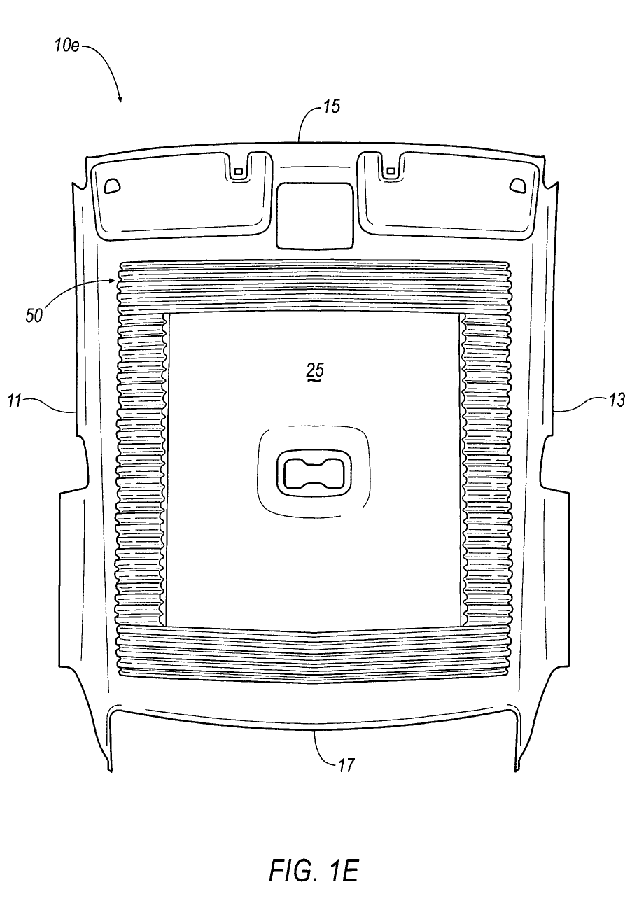

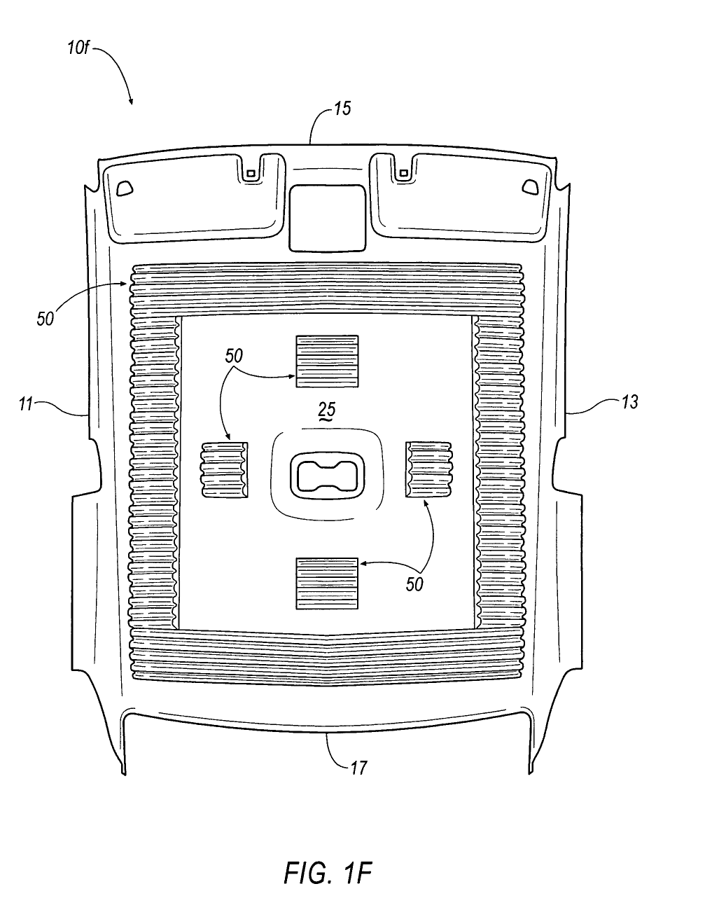

Referring initially to FIG. 1A, a headliner is shown generally at 10a according to an embodiment of the invention. The headliner 10a is shaped to conform to the contour of a roof of the passenger compartment area of a vehicle (not shown). As viewed in FIG. 1A, the headliner 10a is defined by a left side 11 and a right side 13, a front end 15, where front seat passengers, such as a driver and/or navigator are located, and a rear end 17, where back-seat passengers, such as second or third row passengers are located. As illustrated, the headliner 10a may include a plurality of recesses 12 for interior components, such as, for example, visors, garment hooks, grab-handles, or the like. The recesses 12, as illustrated, are located at the front end 15, however, the recesses 12 may be located at any desirable location including the sides 11, 13, rear end 17, or middle area 19. Additionally, the headliner 10a may further comprise a plurality of passages 14 for feeding electrical wiring to the recesses 12, an overhead console location 16, a dome lamp/entertainment system location 18, or the like.

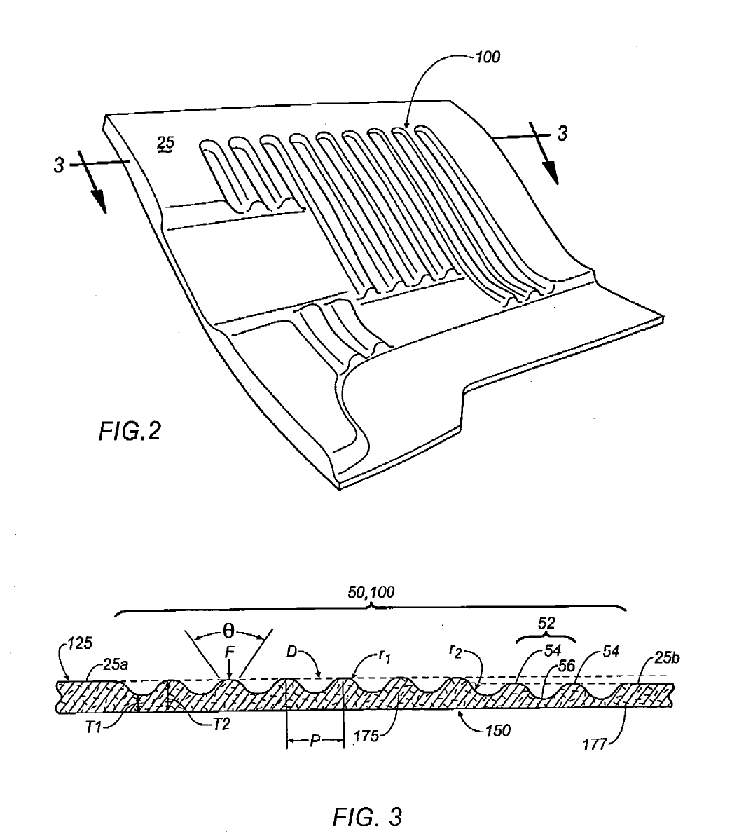

As seen in FIG. 1A, the headliner 10a includes an exterior surface 25 that generally conforms to an A-side surface and a plurality of integrally-molded energy distribution zones 50. Each zone 50 includes a plurality of channels 52, each defined by a valley 56 intermediately-located between two peaks 54 (FIG. 3), to function in the energy distribution of a load that may be applied by a force, F (FIG. 3), to the exterior surface 25 of the headliner 10a. In one embodiment of the invention, each zone 50 may be shaped in an embossed form such that the zones 50 protrude from the exterior surface 25. In an alternative embodiment shown in FIG. 2, each zone 100 may be shaped in a recessed form such that each peak 54 terminates on a same plane, defined by a dashed line, D (FIG. 3), as that of the exterior surface 25. Additionally, each zone 50, 100 may not necessarily reside on a same plane, as shown by the dashed line, D; for example, as shown in FIG. 3, the zone 50, 100 is defined to include channels 52 that reside on two different planes, which are referenced from exterior surfaces 25a, 25b and dashed lines, D.

Referring to FIG. 3, the preferred embodiment of each zone 50, 100 has one or more generally sinusoidal cross-sectional shapes defined by peaks 54 and a valley 56 defining a channel 52 to provide an optimum geometry for the distribution of the energy from the load applied by the force, F. As illustrated, each zone 50, 100 enable the peaks 54 and valleys 56 to absorb and distribute the force, F, applied from any direction as shown by the angle, θ. Additionally, when the force, F, is applied in a direction lengthwise along each zone 50, 100, the zone 50, 100 may be softer than when the force, F, is applied in a direction traversing (i.e. perpendicular) the length of each zone 50, 100. Thus, the sinusoidal cross-sectional shape of each zone 50, 100 provides for a variation in the relative hardness and softness of the zone 50, 100, depending on the direction in which the force, F, is applied to the zone 50, 100. It will be appreciated that many variations in the relative hardness and softness of each zone 50, 100 are within the contemplation of the invention.

The channels 52 are also not limited to having constant amplitude, which is referenced from thickness T1, T2, or a constant period, P. For example, the amplitude may vary continuously throughout the zone 50 such that peaks 54 may be recessed below the dashed line, D, or, alternatively, the peaks 54 may extend past the dashed line, D. Additionally the frequency of each peak 54 may vary by lengthening the period, P, or shortening the period, P. Also, each peak and valley may have variable designs by varying the corner radii, r₁, r₂. According to one embodiment of the invention, the thicknesses T1, T2 may be approximately equal to 7.00 mm and 14.00 mm, respectively, and the corner radii, r₁, r₂ may be approximately equal to 5.00 mm each. Although the preferable embodiment of the invention has been described with sinusoidal periods, P, and each zone 50 is not limited to be a sinusoidal period, P, and may be, if desired, any shape including, but not limited to, for example, flattened or pointed periods, P.

Referring now to FIGS. 1A-1F, the zones 50 may be in the form of patches (FIGS. 1A and 1B) disposed about the headliner 10a in any desirable configuration. For example, as seen in FIG. 1A, the headliner 10a includes four zones 50 that are generally located about each corner of the headliner, which corresponds to the driver, front passenger, and left- and right-side rear passengers. As seen in FIG. 1B, a headliner 10b includes eight zones 50 located in a three-by-three row and column configuration, with an absence of a zone 50 in the middle of the headliner where a central passage for a dome lamp would be located. In one application scenario, the headliner 10b may be applied in a sport utility vehicle (SUV) that includes second- and third-row seating, whereas the headliner 10a that includes zones 50 in a two-by-two row and column may be applied in a sedan-type automobile. However, a sedan-type vehicle may not necessarily be limited to four zones 50, and may include, for example, a fifth or sixth zone 50 located between the zones 50 at each corner such that the zones 50 forms a two-by-three row and column configuration with an absence in the middle of the headliner near the dome lamp opening. Even further, although row and column dispositions of the zones 50 are shown, the zones 50 may be disposed in any desirable configuration.

As seen in FIGS. 1C and 1D, rather than being in the form of patches (FIGS. 1A and 1B), the zones 50 may include strips extending the length of the headliner 10c (FIG. 1C) or the width of the headliner 10d (FIG. 1D). If desired, the zones 50 as shown in FIGS. 1C and 1D may be combined to form a zone 50 in the form of a rectangle disposed about the length and width of the headliner 10e (FIG. 1E). As seen in FIG. 1F, the headliner 10f may include a combination of patch zones 50 as well as a zone 50 extending the length and width of the headliner in a similar fashion as shown in FIG. 1E. Although the zones 50 shown in FIGS. 1A-1F are disposed in a generally row, column, length and width configuration, the zones 50 may be disposed in any desirable configuration.

In addition to the advantages described above relating to the distribution of the load, F, the channels 52 are preferable to maintain consistency of the final form of the headliner 10a-10f once the manufacturing process is completed. The manufacturing process of the headliner 10a-10f includes inserting a covering layer, such as a film 150, over a mold half (not shown). Then, a core 175, such as a urethane material, is foamed over the film 150. Next, another layer of film 125 is applied to the exterior surface 25 of the core 175. Then, the mold is closed, allowing the core 175 to expand between the films 125, 150. Next, the molded headliner 10a-10f is removed from the mold tool with the films 125, 150 adhering to the core 175. Because of the core 175 being made of urethane material, the core 175 may form a substrate of the headliner 10a-10f. A decorative covering layer (not shown) may be applied to the film 125 to form an A-surface of the molded headliner 50, 100 exposed to the passengers of the vehicle. When installed in the vehicle, the film 150 may form the B-surface positioned adjacent the roof (not shown) of the vehicle. It will be appreciated that the headliner 50, 100 can include additional layers of material as contemplated by one skilled in the art.

The consistency of the headliner 10a-10f is maintained by integrally molding the zones 50, 100 with the headliner 10a-10f during the manufacturing process described above, rather than adhering conventional crush zones to a substrate or core material. Additionally, the sinusoidal patterns of the integrally-molded zones 50, 100 maintains each film 125, 150 disposed over the upper and lower mold halves because the flow pattern of the foamed urethane 175 flows with the shape of the mold tool cavity that defines the zones 50, 100. If the zones 50, 100 comprise flattened or pointed surfaces, the flow pattern of the foamed urethane 175 may undesirably punch through the A-surface film 125 at a sharp point of the cavity defining the zone 50, 100. One technique that may be used to manufacture the headliner 10a-10f is described in U.S. Pat. No. 5,683,796, entitled, “Spray Urethane Method Of Making A Headliner Assembly,” to Kornylo et al., which is assigned to the assignee of the present invention, the entire contents of which are herein incorporated by reference. As a result, each zone 50, 100 not only increases the thickness of the headliner 10a-10f without having to adhere additional countermeasures, but the manufacturing cycle time and cost is maintained by integrally and locally molding the zones 50, 100 with the headliner core 175.

It should be understood that the aforementioned and other various alternatives to the embodiments of the invention described herein may be employed in practicing the invention. It is intended that the following claims define the scope of the invention and that the method and apparatus within the scope of these claims and their equivalents be covered thereby.

1. A vehicular interior trim component, comprising:
a core made of foam material having an exterior surface with at least one integrally-molded energy distribution zone comprising a series of undulations.

2. The vehicular interior trim component according to claim 1, wherein the at least one integrally-molded energy distribution zone is embossed from the exterior surface.

3. The vehicular interior trim component according to claim 1, wherein the at least one integrally-molded energy distribution zone is recessed within the exterior surface.

4. The vehicular interior trim component according to claim 1, wherein the integrally-molded energy distribution zone has a generally sinusoidal cross-sectional shape.

5. The vehicular interior trim component according to claim 1, wherein the core comprises urethane material.

6. The vehicular interior trim component according to claim 5, wherein the urethane material includes fiberglass reinforcing fibers.

7. The vehicular interior trim component according to claim 1, wherein the vehicular interior trim component comprises a headliner.

8. A headliner, comprising:
a core made of foam material having an exterior surface with at least one integrally-molded energy distribution zone comprising a series of undulations.

9. The headliner according to claim 8, wherein the at least one integrally-molded energy distribution zone is embossed from the exterior surface.

10. The headliner according to claim 8, wherein the at least one integrally-molded energy distribution zone is recessed within the exterior surface.

11. The headliner according to claim 8, wherein the integrally-molded energy distribution zone has a generally sinusoidal cross-sectional shape.

12. The headliner according to claim 8, wherein the core comprises urethane material.

13. The headliner according to claim 12, wherein the urethane material includes fiberglass reinforcing fibers.

14-17. (canceled)

18. A headliner, comprising:
a core made of thermoset foam material having an exterior surface with at least one integrally-molded energy distribution zone having a cellular structure comprising a series of undulations.

19. The headliner according to claim 18, wherein the at least one integrally-molded energy distribution zone is embossed from the exterior surface.

20. The headliner according to claim 18, wherein the at least one integrally-molded energy distribution zone is recessed within the exterior surface.

21. The headliner according to claim 18, wherein the integrally-molded energy distribution zone has a generally sinusoidal cross-sectional shape.

22. The headliner according to claim 18, wherein the core comprises urethane material.

23. The headliner according to claim 22, wherein the urethane material includes fiberglass reinforcing fibers.

24. The headliner according to claim 18, wherein the at least one integrally-molded energy distribution zone is substantially uniform in density.

25. The headliner according to claim 1, wherein the at least one integrally-molded energy distribution zone is substantially uniform in density.

26. The headliner according to claim 8, wherein the at least one integrally-molded energy distribution zone is substantially uniform in density.
